(19) United States
(12) Patent Application Publication
(10) Pub. No.: US 2007/0275617 A1
(43) Pub. Date: Nov. 29, 2007

(54) Decorative flame barrier surface covering

(75) Inventors: Billy Evans Harris, Anderson, SC (US); Michael Preston Hinson, Pendleton, SC (US); Robert Rhodes Lanier, Easley, SC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: WP IP, LLC, West Point, GA (US)

(21) Appl. No.: 11/440,849

(22) Filed: May 25, 2006

(51) Int. Cl. B32B 5/02

(52) U.S. Cl. 442/59; 442/136; 442/138; 427/393.3

(57) ABSTRACT

A method of making a decorative flame barrier surface covering in which a first material as a base layer is obtained. A stiffening solution is applied to the base layer, and a flame barrier coating is applied to the stiffened base layer. A second material having a decorative design thereon is obtained as a decorative layer. A functional finish is optionally applied on the decorative layer. The base layer is combined with the decorative layer to form the decorative flame barrier surface covering of the present invention. The decorative flame barrier surface covering of the present invention achieves a Class A certification under American Society for Testing and Materials standard E84-04 without an inherently flame-resistant material as the first or second material.

### FIELD OF THE INVENTION

The present invention relates to a decorative surface covering that serves as a flame barrier. The present invention also relates to a method of making the decorative flame barrier surface covering.

### BACKGROUND OF THE INVENTION

The construction and home furnishings industries have attempted to provide both decorative and functional surface coverings for walls, floors, and ceilings. However, a long standing problem that exists even with such surface coverings has been flammability. This has been of particular concern both in single family dwellings as well as in hotels, office buildings and other places where large numbers of people stay or gather. Thus, there is a need for aesthetically pleasing surroundings, but also the need to reduce or minimize flame spread in the event of a fire. Additionally, there is a need for a cost effective decorative surface covering that does not require the use of expensive, inherently flame-resistant materials, but that still achieves the highest certifications for flame resistance. The decorative flame barrier surface covering of the present invention attempts to fulfill these needs.

### SUMMARY OF THE INVENTION

The decorative flame barrier surface covering of the present invention comprises a first material that is stiffened and treated with a flame barrier coating, and also comprises a second material having a decorative design printed thereon. The decorative flame barrier surface covering of the present invention is able to achieve a Class A certification under American Society for Testing and Materials standard E84-04 without the use of expensive, inherently flame-resistant materials.

Furthermore, the present invention relates to a method of making the decorative flame barrier surface covering. The method comprises obtaining a first material as a base layer. A stiffening solution is applied to the base layer, and a flame barrier coating is applied to the stiffened base layer. A second material is obtained either having a decorative design already thereon or suitable for printing a decorative design thereon to be used as a decorative layer for the surface covering. A functional finish(es) may optionally be applied on the decorative layer to impart any desired properties such as fungal and antimicrobial resistance and stain repellency. In accordance with the method of the present invention, the base layer is combined with the decorative layer to form the decorative flame barrier surface covering.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a textile finish range with on frame “knife over roll” coater suitable for use in accordance with the present invention as set forth in Example 1.

FIG. 2 is an enlarged view of a first section of the textile finishing range shown in FIG. 1.

FIG. 3 is an enlarged view of a second section of the textile finishing range shown in FIG. 1.

FIG. 4 is an enlarged view of a third section of the textile finishing range shown in FIG. 1.

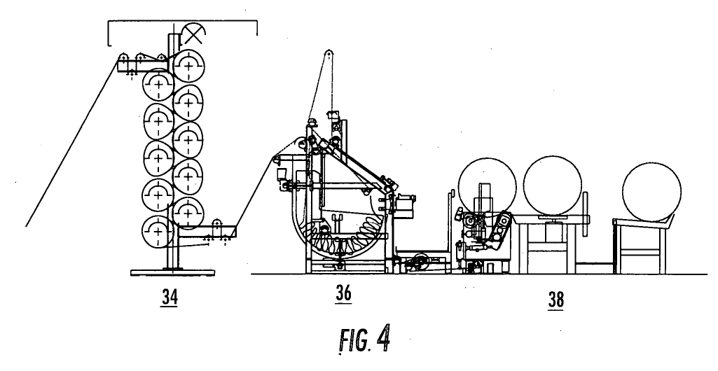

FIG. 5 is a side view of a rotary screen print range in accordance with Example 1.

FIG. 6 is a side view of a laminating range in accordance with Example 1.

FIG. 7 is a graphical representation of time (minutes) versus Cold Side Max temperature (° F.) for samples tested pursuant to ASTM E119 in accordance with Example 3.

FIG. 8 is a graphical representation of time (minutes) versus Average Cold Side temperature (° F.) for samples tested pursuant to ASTM E119 in accordance with Example 3.

### DESCRIPTION OF THE PREFERRED EMBODIMENTS

The following description of the preferred embodiment(s) is merely exemplary in nature and is in no way intended to limit the invention, its application, or uses.

The present invention relates to a decorative surface covering, in particular a decorative flame barrier surface covering. The term “surface”, as used herein, includes, but is not limited to, a wall, a floor, and a ceiling. The method of making the decorative surface covering of the present invention generally comprises: (1) obtaining a first material as a base layer, (2) applying a stiffening solution to the base layer, (3) applying a flame barrier coating to the stiffened base layer, (4) obtaining a second material as a decorative layer, and (5) optionally applying a functional finish(es) on the decorative layer, and (6) combining the base layer with the decorative layer.

According to the method of the present invention, a material for use as a base layer is obtained. The material may be synthetic, natural, or a combination thereof. Examples of synthetic materials include, but are not limited to, polyamide, acetate, nylon, modacrylic, olefin, acrylic, polyester, polylactic acid (PLA), aramid, modal, sulfar, and zylon. Synthetic materials may also include synthetic fibers regenerated from naturally occurring materials such as rayon and lyocell regenerated from naturally occurring cellulose. Lyocell is commercially available as TENCEL® from Lenzing Fibers. Examples of natural materials include, but are not limited to, wood pulp, cotton, jute, flax, ramie, hemp, kenaf, abaca, nettles, bamboo, esparto, coir, and sisal. The material of the base layer may be in any form including, but not limited to, knit, woven, and non-woven. Preferably, the material of the base layer is a non-woven. More preferably, the non-woven is a hydroentangled blend of polyester and lyocell.

The base layer is treated with a stiffening solution. The term “stiffening solution,” as used herein, refers to any chemical treatment that is used to stiffen a material. Examples of stiffening solutions include, but are not limited to, polymeric solutions. An example of a preferred stiffening solution comprises: water, melamine, and an acrylic emulsion such as HYCAR® commercially available from Noveon, Inc. For example, the base layer may be processed through a standard tenter frame pad and cure process comprising, for example, fabric entry, padding of liquid chemicals, vacuum extractor, gas pre-drying, steam pre-drying, convection oven curing, and fabric take up. The base layer may be treated with the stiffening solution using any application method known to one of ordinary skill in the art. Examples of application methods include, but are not limited to, padding, spraying, and coating. However, any application method known to one of ordinary skill in the art may be used. The treatment with the stiffening solution provides for a stiffer base layer.

Once the base layer is treated with the stiffening solution, the base layer may travel through a drying device. The stiffened base layer may then be routed through a textile machine such as a tenter frame to undergo a coat and/or cure process comprising, for example, fabric entry, coating application, convection oven curing, and fabric take up. A machine such as a textile finishing range may be used that is equipped with a coating device, preferably a “knife over roll” coating device, which is positioned in a fixed area (“on frame”) prior to an oven entrance. The coating device is used to apply a flame barrier coating to the base layer. The flame barrier coating is preferably applied in an amount in the range of from about 2 to about 9 (dry ounces/square yard) add on. However, depending upon the flame barrier coating selected, the amount of add on may vary yet still be within the scope of the present invention. Preferably, the coating device has a supply line fed by a material foaming apparatus. Foam application is particularly advantageous because it allows entrained air to be incorporated into the flame barrier coating. The blow ratio is a volumetric ratio that represents the ratio of air to flame barrier coating. It is preferred that the blow ratio in the method of the present invention be in the range of from about 0.8:1 to about 2:1. The extra thickness resulting from the foam application is believed to improve the flame barrier characteristics of the decorative surface covering. The flame barrier coating may be a polymer based intumescent graphite coating. An example of a polymer based intumescent graphite coating suitable for use in the present invention is MYFLAME 3921, commercially available from Noveon, Inc. With the base layer stiffened and the barrier flame coating applied to the base layer, the base layer is set aside to await subsequent processing.

In accordance with the method of the present invention, a second material is obtained. The second material may be synthetic, natural, or a combination thereof. Examples of synthetic materials include, but are not limited to, polyamide, acetate, nylon, modacrylic, olefin, acrylic, polyester, polylactic acid (PLA), aramid, modal, sulfar, and zylon. Synthetic materials may also include synthetic fibers regenerated from naturally occurring materials such as rayon and lyocell regenerated from naturally occurring cellulose. Lyocell is commercially available as TENCEL® from Lenzing Fibers. Examples of natural materials include, but are not limited to, wood pulp, cotton, jute, flax, ramie, hemp, kenaf, abaca, nettles, bamboo, esparto, coir, and sisal. The material of the base layer may be in any form including, but not limited to, knit, woven, and non-woven. Preferably, the material of the second layer is a non-woven. More preferably, the non-woven is a hydroentangled blend of polyester and lyocell. More preferably, the second layer is of a material identical to that of the base layer. The second layer may have a decorative design already applied thereon or a design may be printed upon it during processing. If the second layer has no decorative design when obtained, the second material is routed to a print machine. The print machine may be of any type known to one of ordinary skill in the art including, but not limited to, rotary screen, digital inkjet, engraved steel roller, transfer, and flat bed. Preferably, the print machine is a rotary screen print machine. A typical rotary screen print machine comprises a unit for decorative pattern application and an oven. Using the unit for decorative pattern application, the print machine prints a decorative pattern as is typical of a commercial grade wallpaper on the second material. The second material having a decorative design thereon is then dried and cured in an oven to form the decorative layer. The decorative layer is optionally treated with one or more functional finishes. A functional finish is a chemical finish that provides some additional benefit or protection to the material. An example of a functional finish includes, but is not limited to: a flame retardant; anti-fungal agent; antimicrobial agent; fluorocarbon such as for water, oil, alcohol, and stain repellency; and a wrinkle-resistant finish. A functional finish may be applied, for example, during the decorative printing process either before or after curing. Preferably, treatment with a functional finish may be by any process known to one of ordinary skill in the art. More preferably, the treatment is by a pad and cure process.

In accordance with the method of the present invention, the base layer and the decorative layer are combined together. The combination of the layers may be by any process known to one of ordinary skill in the art. Examples of such processes include, but are not limited to, lamination/calendaring, ultrasonic processes, adhesive, stitching, powder coating, and ultrasonic welding. Preferably, the layers are laminated together. Lamination typically involves routing both layers simultaneously through a calendar. With heat and pressure, the calendar laminates the layers together with the aid of a low melting point adhesive scrim which is fed between the two materials. The base layer and the decorative layers are adhered to one another to form the decorative flame barrier surface covering. Once combined, the surface covering may be taken to a cutting operation at which it is trimmed to a desired width. The preferred final thickness of the decorative flame barrier surface covering when used as a wall covering is typically in a range from about 0.03 inches (0.76 mm) to about 0.06 inches (1.5 mm), preferably about 0.04 inches (1 mm).

The decorative flame barrier surface covering of the present invention is designed to perform as a barrier to flame and to receive the highest rating (Class A Certification) under the American Society for Testing and Materials (ASTM) standard E84-04 “Surface Burning Characteristics of Building Materials” and to pass ASTM Test Method E119 “Standard Test Method for Fire Tests of Building Construction and Materials.” The decorative flame barrier surface covering of the present invention achieves this certification without the use of an inherently flame-resistant material. Examples of inherently flame-resistant materials include, but are not limited to, NOMEX® commercially available from E. I. DuPont de Nemours and Company and PBI® commercially available from PBI Performance Products, Inc. It is advantageous that such materials need not be used as they are expensive and would increase the cost of the surface covering. Among the other advantages of the decorative flame barrier surface covering of the present invention is that with the application of a functional finish(es), the decorative flame barrier surface covering of the present invention may also pass other tests desirable in the industry such as the following: ASTM C518 “Standard Test Method for Steady-State Thermal Transmission Properties by Means of Heat Flow Meter Apparatus”; ASTM Test Method 2471 for “Using Seeded-Agar for the Screening Assessment of Antimicrobial Activity in Carpets”; AATCC Test Method 118 for “Oil Repellency: Hydrocarbon Resistance Test”; ASTM Test Method E90 for “Noise Reduction and Sound Transfer”; ASTM Test Method E96 for “Standard Test Method for Water Vapor Transmission of Materials”; and AATCC (American Association of Textile Colorists and Chemists) Test Method 16 for Lightfastness. Another advantage of the decorative flame barrier surface covering of the present invention when used as a wall covering, for example, is that it allows for a reduction in the level of finish required for gypsum board installation. The Association of the Wall and Ceiling Industries-International (AWC), Ceiling and Interior System Construction Association (CISCA), Gypsum Association (GA), and Painting and Decorating Contractors of America, (PDCA), produced a consensus document describing the various levels of finish of gypsum board surfaces prior to the application of specific types of final decoration. These levels range from Level 0 to Level 5. Level 0 requires no taping, finishing, mudding, or accessories. Level 5 has all joints and interior angles tape embedded in joint compound and two separate joint compound applications on all flat joints. Nail heads and screws must have three separate coatings of joint compound. The detailed specifications for Level 1 through Level 5 are outlined in the Gypsum Association document GA-214. The decorative flame barrier surface covering of the present invention when used as a wall covering falls approximately between Level 0 and Level 1. This is advantageous to the wall covering industry because the elimination of the labor and materials required to finish the gypsum board to the higher levels required for commercial wall paper significantly reduces the costs to a contractor.

Thus, when applied to unfinished wallboard, an advantage of the decorative flame barrier surface covering of the present invention is that it will hide the imperfections (i.e. unmudded seams, nail holes, etc.) in an unfinished surface such that the appearance of the decorative wall covering/unfinished wallboard surface would aesthetically look the same as a decorative wall covering/finished wallboard surface.

The present invention may be better understood by reference to the following non-limiting examples, set forth below.

### EXAMPLES

### Example 1

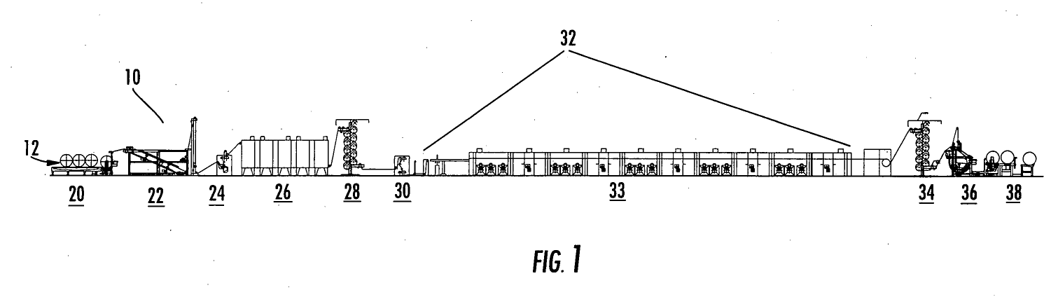

FIG. 1 is a side view of a textile finishing range suitable for use in accordance with the present invention. A non-woven material 12 was obtained under the experimental listing “BH-111004-100” from Polymer Group, Inc. The non-woven material was a hydroentangled blend (50/50) of polyester and lyocell fibers with an overall weight of 100 grams per square meter. The non-woven material 12 was used in a single layer as a base layer.

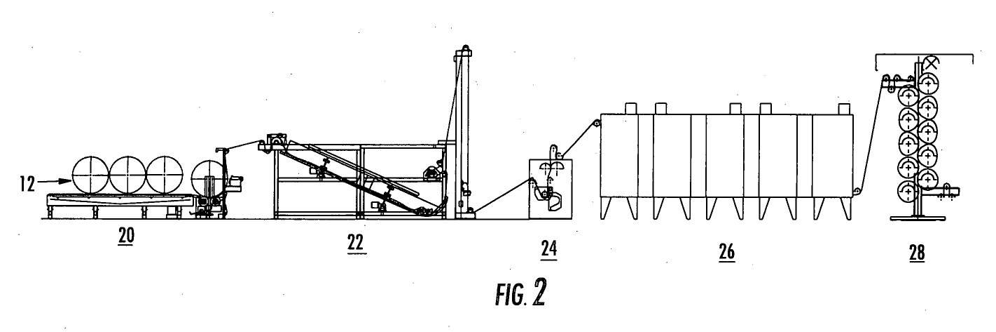

As shown in FIG. 1, the textile finish range has an on frame “knife over roll” coater suitable for use in accordance with the present invention. As shown in FIG. 1, the non-woven material 12 was processed through a textile finishing range 10. The finish range settings were as follows: range speed 80 yards per minute (YPM); chemical pad pressure 60 PSI; gas fired pre-dryers off; vacuum extractor off; steam filled drying cans zone settings 20/20/30 PSI (steam pressure); gas heated tenter oven zone temperatures 250° F., 275° F., and 350° F. As shown in FIG. 2, the non-woven material 12 was placed on the entry table 20 and was then mechanically fed into the entry scray 22. After exiting the entry scray 22, a finishing pad 24 was used to apply a stiffening solution to the non-woven material 12. The stiffening solution comprised: 59% HYCAR™ 26-1475 (Noveon, Inc.), 39% water, and 2% melamine. The non-woven material 12 entered a predryer 26 and 10 can dry stack 28 to remove excess water. The non-woven material 12 bypassed the coating device 30 and exited the finishing range.

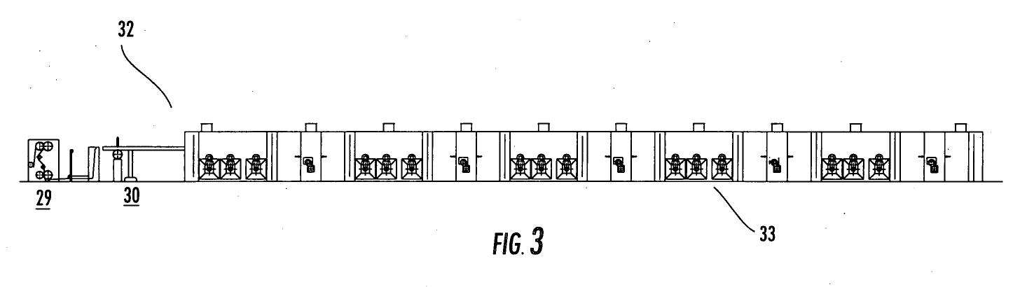

As shown in FIG. 3, the non-woven material 12 was then routed through another tenter frame 32 that comprised a fabric straightener 29, an “on frame” knife over roll coating device 30, and an oven 33 to undergo a coat/cure process (fabric entry, coating application, convection oven curing, fabric take up). The knife over roll coating device 30 was positioned in a fixed area (“on frame”) prior to the oven 33. Additionally, the knife over roll coating device had a supply line fed by a material foaming apparatus (not shown). The foaming apparatus allowed entrained air to be incorporated into the flame barrier coating. The flame barrier coating was a polymer based intumescent graphite emulsion. MYFLAME 3921 manufactured by Noveon, Inc. was used. Machine settings for the knife roll over coater were as follows: coating blade type 10 back; blade height +0.100 inches (above stationary roll); and blow ratio of 1:1.

The non-woven material was cured in the oven 33 for approximately 30 seconds in the continuous process. After exiting the oven 33, the non-woven material was cooled in a 10 can dry stack 34 and then passed through the exit scray 36 and subsequently rolled onto the exit table 38. The final dry add on for the stiffening solution was between 1 and 1.5 oz/sq yd.

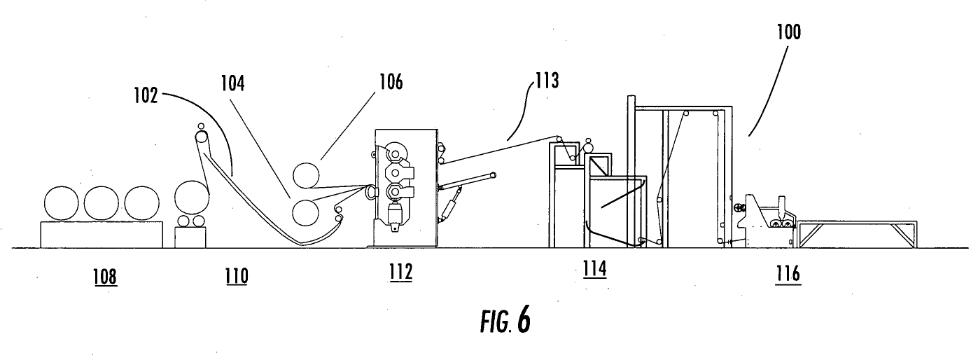

With the stiffening solution added and flame barrier coating applied, the non-woven material was placed in storage to await subsequent processing as the base layer 102 shown in FIG. 6.

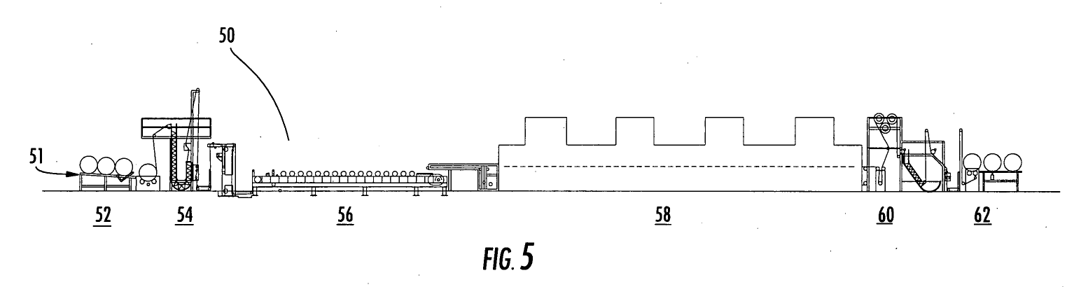

To begin the steps necessary to make the decorative layer of the finished product as shown in FIG. 5, a roll of non-woven material 51 was obtained. Non-woven material 51 was identical to the material used in the base layer. The non-woven material 51 was first routed down to a rotary screen print range 50, as shown in FIG. 5. The non-woven material 51 was placed on the entry table 52 and was then mechanically fed into the entry scray 54. Using the commercially available print chemical systems of AlcoPrint PTN from Ciba Specialty Chemicals and PrintRite 594 from Noveon, Inc. for decorative pattern application 56, a decorative pattern similar to any of those appearing on commercial grade wallpaper was printed on the non-woven material 51. Printing the decorative design on the non-woven material 51 as opposed to being pre-printed on the material provided flexibility to engrave the print screens in such manner to allow ease of installation by purposely modifying repeat sizes, match lines, and joint points. The non-woven material 51 was then dried and cured in a gas fired convection oven 58. The non-woven material 51 then exited the exit scray 60 and was placed on the exit table 62.

The printed non-woven material 51 was then routed down the finishing range 10 where functional finishes were added via the pad/cure process described above bypassing the coater 30. The functional finishes included a flame inhibitor (PYROSAN SYN), a water soluble antimicrobial product having an active biocide of 5-chloro-2-(2,4-dichlorophenoxy) phenol (ULTRAFRESH NM-V2), and a perfluoronated acrylate emulsion (FREEPEL FC-45) designed to give water, oil, alcohol, and stain repellency. The aforementioned functional finishes were manufactured by Noveon, Inc. The concentrations of the functional finishes in the pad bath were as follows: 20% PYROSAN SYN; 2.5% FREEPEL FC-45; and 1.6% ULTRAFRESH NM-V2. Machine settings were as follows: range speed 80 YPM; chemical pad pressure 60 PSI; vacuum extractor off; gas fired pre-dryers on (burning at approximately 1300° F.); steam filled drying cans zone settings 20/20/30 PSI (steam pressure); gas heated tenter oven zone temperatures 350° F., 350° F., and 350° F. The chemically treated, printed non-woven material 51 was set aside to be used as the decorative layer 106 of the decorative flame barrier surface covering of the present invention.

Subsequently, both the base layer 102 and the decorative layer 106 were combined together in a laminating process. As shown in FIG. 6, the laminating process involved routing the base layer 102 and the decorative layer 106 simultaneously to a laminating range 100. The base layer was placed on entry table 108 and was then mechanically fed into entry scray 110 to a laminator/calendar 112. The calendar 112 was a “S” wrap type with a Nylon/Steel/Nylon configuration manufactured by Kusters. With heat and pressure, the calendar laminated the base layer 102 and the decorative layer 106 together with a low melting point adhesive scrim 104 which was fed between the two layers. The adhesive scrim product PA1008-035-061 was supplied by SPUNFAB® Dry Adhesive Technologies. The adhesive scrim 104 allowed for the base layer 102 and decorative layer 106 to be adhered to one another. The laminating process involved the following calendar setpoints: machine speed 20 YPM; top swim roll pressure 100 PSI; bottom swim roll pressure 80 PSI; nip pressure 900 PLI; cylinder pressure 1250 PSI; cylinder temperature 350° F.

The decorative flame barrier surface covering 113 exited the calendar 112 and was then mechanically fed into exit scray 114 and was placed on exit table 116. The decorative flame barrier surface covering 113 was then taken to a cutting operation where it was trimmed to the desired width and prepared for shipping and distribution. The final thickness of the decorative flame barrier surface covering for use as a wall covering was approximately 1 millimeter.

### Example 2

A decorative flame barrier surface covering for use as a decorative wall covering was prepared in accordance with Example 1 of the present invention. Samples 1 to 4 were obtained from the wall covering and were treated as shown in Table 1. The samples were evaluated pursuant to ASTM Test Method E84-04 for “Surface Burning Characteristics of Building Materials”, incorporated herein by reference.

TABLE 1

| | Flame Retardant - | Functional | Functional | Functional | | | |
|---|---|---|---|---|---|---|---|
| | MYFLAME | Chemistry- | Chemistry- | Chemistry- | | | Additional |
| | 3921 (dry | PYROSAN | ULTRAFRESH | FREEPEL | | | graphite in |
| Sample | ounce/sq yd) | SYN (% in | NM-V2 (% in | FC-45 (% in | | | MYFLAME |
| No. | add on | finish mix) | finish mix) | finish mix) | Laminated | Stiffened | 3921?* |
| 1 | 2.8 | 0 | 0 | 0 | Yes | Yes | No |
| 2 | 8.3 | 0 | 0 | 0 | Yes | No | No |
| 3 | 3.1 | 0 | 1.6 | 2.5 | Yes | Yes | No |
| 4 | 3.5 | 20 | 1.6 | 2.5 | Yes | Yes | No |

*Note: for samples tested with “additional graphite”, the level used was twice the amount of the original.

In order to meet the requirements for Class A certification under ASTM Test Method E84-04 for “Surface Burning Characteristics of Building. Materials,” a sample must exhibit a flame spread index less than 25 and a Smoke Developed Index less than 450.

ASTM Test Method E84-04 is used to determine the comparative surface burning behavior of building materials. The test is applicable to exposed surfaces, such as ceilings or walls, provided that the material or assembly of materials, by its own structural quality or the manner in which it is tested and intended for use, is capable of supporting itself in position or being supported during the test period. The purpose of the method is to determine the relative burning behavior of a material by observing the flame spread along the sample. Flame spread and smoke density are determined. There is not necessarily a relationship between these two measurements.

Pursuant to the ASTM E84-04 Test Method, the surface flame spread and smoke developed measurements were compared to those obtained from tests of mineral fiber cement board and select grade red oak flooring. The test specimen surface (18 inches wide and 24 feet long) was exposed to a flaming fire exposure during the 10 minute test duration, while flame spread over its surface and density of the resulting smoke were measured and recorded. Test results were presented as the computed comparisons to the standard calibration materials. The furnace was considered under calibration when a 10 minute test of red oak decking passed flame out the end of the tunnel in five minutes, 30 seconds, plus or minus 15 seconds. Mineral fiber cement board formed the zero point for both flame spread and smoke developed indexes, while the red oak flooring smoke developed index was set as 100.

Sample 1 was a stiffened, laminated non-woven wall covering material with a 2.8 dry ounce add on of foam applied flame barrier coating. The decorative top layer had no functional finishes. The sample consisted of three 8 foot long×24 inch wide×0.7020 inch thick, laminated, non-woven wall covering adhered to ⅝ inch thick, gypsum board using Gibson-Homans Shur-Stik 111 Clay based heavy duty adhesive at a calculated coverage rate of 17 oz per 8 foot board. The wall covering was white/blue in color. The self-supporting samples were placed directly on the tunnel ledges. After the tests, the samples were removed from the tunnel, examined and disposed of.

Sample 1 was conditioned at 73° F. and 50% relative humidity for 8 days. The sample width was 24 inches and sample length was 24 feet. The sample thickness was 0.7020 inches. The material weight was 2.8 oz/sq. yd. The total sample weight was 116.10 pounds. The adhesive or coating application rate was 17 oz. per 8 ft board. The sample was self-supporting and was placed directly on the inner ledges of the tunnel.

Sample 2 was a non-stiffened, laminated non-woven wall covering material with a 8.3 dry ounce add on of foam applied flame barrier coating. The decorative top layer had no functional finishes. The sample consisted of three 8 foot long×24 inch wide×0.6835 inch thick, laminated, non-woven wall covering adhered to ⅝ inch thick, gypsum board using Gibson-Homans Shur-Stik 111 Clay based heavy duty adhesive at a calculated coverage rate of 17 oz per 8 foot board. The wall covering was white/blue in color. The self-supporting sample was placed directly on the inner ledges of the tunnel. After the tests, the samples were removed from the tunnel, examined and disposed of.

Sample 2 was conditioned at 73° F. and 50% relative humidity for 8 days. The sample width was 24 inches and sample length was 24 feet. The sample thickness was 0.6835 inches. The material weight was 8.3 oz/sq. yd. The total sample weight was 116.00 pounds. The adhesive or coating application rate was 17 oz. per 8 ft board. The sample was self-supporting and was placed directly on the inner ledges of the tunnel.

Sample 3 was a stiffened, laminated non-woven wall covering material with a 3.1 dry ounce add on of foam applied flame barrier coating. The decorative top layer had functional finishes containing an antimicrobial and a fluorocarbon component. The specimen consisted of three 8 foot long×24 inch wide×0.6685 inch thick, laminated, non-woven wall covering adhered to ⅝ inch thick, gypsum board using Gibson-Homans Shur-Stik 111 Clay based heavy duty adhesive at a calculated coverage rate of 17 oz per 8 foot board. The wall covering was white/blue in color. The self-supporting samples were placed directly on the tunnel ledges. After the tests, the samples were removed from the tunnel, examined and disposed of.

Sample 3 was conditioned at 73° F. and 50% relative humidity for 8 days. The sample width was 24 inches and sample length was 24 feet. The sample thickness was 0.6685 inches. The material weight was 3.1 oz/sq. yd. The total sample weight was 116.20 pounds. The adhesive or coating application rate was 17 oz. per 8 ft board. The sample was self-supporting and was placed directly on the inner ledges of the tunnel.

Sample 4 was a stiffened, laminated non-woven wall covering material with a 3.5 dry ounce add on of foam applied flame barrier coating. The decorative top layer had functional finishes containing antimicrobial, fluorocarbon, and flame retardant components. The sample consisted of three 8 foot long×24 inch wide×0.6705 inch thick, laminated, non-woven wall covering adhered to ⅝ inch thick, gypsum board using Gibson-Homans Shur-Stik 111 Clay based heavy duty adhesive at a calculated coverage, rate of 17 oz per 8 foot board. The wall covering was white/blue in color. The self-supporting samples were placed directly on the tunnel ledges. After the tests, the samples were removed from the tunnel, examined and disposed of.

Sample 4 was conditioned at 73° F. and 50% relative humidity for 8 days. The sample width was 24 inches and sample length was 24 feet. The sample thickness was 0.6705 inches. The material weight was 3.5 oz/sq. yd. The total specimen weight was 116.30 pounds. The adhesive or coating application rate was 17 oz. per 8 ft board. The sample was self-supporting and was placed directly on the inner ledges of the tunnel.

The test results were computed on the basis of observed flame front advance and electronic smoke density measurements. The results are shown in Table 2. The results were computed to the nearest number divisible by 5, as outlined in the test method for smoke developed index results greater than 200 the calculated value is rounded to the nearest 50 points.

TABLE 2
Test results

| Test specimen | Flame Spread Index | Smoke Developed Index |
|---|---|---|
| Mineral Fiber Cement | 0 | 0 |
| Board | | |
| Red Oak Flooring | 85 | 85 |
| Sample 1 | 25 | 0 |
| Sample 2 | 25 | 45 |
| Sample 3 | 25 | 35 |
| Sample 4 | 25 | 50 |

For Sample 1, the test results indicated a Flame Spread Index of 25 and a Smoke Developed Index of 0. With respect to Sample 1, the following observations were made. The wall covering began to melt at 0:08 (min:sec). The specimen ignited at 0:14 (min:sec). Minute pieces of the wall covering began to fall from the substrate at 3:38 (min:sec). The test continued for the 10:00 duration. After the test the specimen was observed to be damaged as follows. The wall covering was charred from 0 ft to 8 ft. Dark discoloration was observed to the wall covering from 8 ft to 11 ft. Light discoloration was observed to the wall covering from 11 ft to 24 ft.

For Sample 2, the test results indicated a Flame Spread Index of 25 and a Smoke Developed Index of 45. With respect to Sample 2, the following observations were made. The wall covering began to melt at 0:09 (min:sec). The wall covering ignited at 0:12 (min:sec). Minute pieces of the wall covering began to fall from the substrate at 0:37 (min:sec). The flames began to flash at the 8 ft joint at 8:49 (min:sec). The test continued for the 10:00 duration. After the test Sample 2 was observed to be damaged as follows. The wall covering was consumed from 0 ft to 12 ft. Light discoloration was observed to the wall covering from 12 ft to 24 ft.

For Sample 3, the test results indicated a Flame Spread Index of 25 and a Smoke Developed Index of 35. With respect to Sample 3, the following observations were made. The wall covering began to char at 0:09 (min:sec). The wall covering ignited at 0:14 (min:sec). The test continued for the 10:00 duration. After the test Sample 3 was observed to be damaged as follows. The wall covering was charred and cracked from 0 ft to 9 ft. Dark discoloration was observed to the wall covering from 9 ft to 11 ft. Light discoloration was observed to the wall covering from 11 ft to 24 ft.

For Sample 4, the test results indicated a Flame Spread Index (FSI) of 25 and a Smoke Developed Index of 50. With respect to Sample 4, the following observations were made. The wall covering ignited at 0:09 (min:sec). Minute pieces of the wall covering began to flake off the gypsum board substrate at 5:19 (min:sec). The test continued for the 10:00 duration. After the test, the specimen was observed to be damaged as follows. The wall covering was charred from 0 ft to 14 ft. Light discoloration was observed to the wall covering from 14 ft to 24 ft.

TABLE 3
Specimen Data

| | Sample 1 | Sample 2 | Sample 3 | Sample 4 |
|---|---|---|---|---|
| Time to Ignition (sec) | 14 | 12 | 14 | 9 |
| Time to Max Flame | 215 | 528 | 79 | 295 |
| Spread (sec) | | | | |
| Maximum Flame Spread | 5.2 | 6.3 | 5.3 | 5.3 |
| (feet) | | | | |
| Time to 980° F. (sec) | Never | Never | Never | Never |
| | reached | reached | reached | reached |
| Max Temperature (° F.) | 623 | 705 | 620 | 608 |
| Time to Max | 234 | 527 | 582 | 458 |
| Temperature (sec) | | | | |
| Total Fuel Burned (cubic | 50.70 | 50.62 | 50.67 | 50.56 |
| feet) | | | | |
| FS* Time Area (ft * min) | 46.1 | 51.3 | 50.6 | 50.4 |
| Smoke Area (% A * min) | 2.1 | 39.9 | 31.1 | 41.4 |
| Fuel Area (° F. * min) | 5748.1 | 5797.0 | 5719.7 | 5667.7 |
| Fuel Contributed Value | 9 | 11 | 8 | 7 |
| Unrounded FSI | 23.8 | 26.4 | 26.1 | 26.0 |

TABLE 4
Calibration Data

| | Sample 1 | Sample 2 | Sample 3 | Sample 4 |
|---|---|---|---|---|
| Time to ignition of Last | 39 | 39 | 39 | 39 |
| Red Oak (sec) | | | | |
| Red Oak Smoke | 85.00 | 85.00 | 85.00 | 85.00 |
| Area (% A * min) | | | | |
| Red Oak Fuel | 9036 | 9036 | 9036 | 9036 |
| Area (° F. * min) | | | | |
| Glass Fiber Board Fuel | 5401 | 5401 | 5401 | 5401 |
| Area (° F. * min) | | | | |

The decorative flame barrier wall covering samples 1-4 received a “Class A” (highest possible rating) pursuant to this ASTM E84-04 Test Method.

### Example 3

A decorative flame barrier wall covering was prepared in accordance with Example 1 of the present invention and a sample was treated as set forth in Table 5. Sample 1 was tested pursuant to ASTM Test Method E119 (“Standard Test Methods for Fire Tests of Building Construction and Materials”), herein incorporated by reference. According to the test method, the purpose of the procedure is to prescribe a standard exposing fire of controlled extent and severity, in this case to a wall assembly, such that performance is defined as the period of resistance to standard exposure elapsing before the first critical point in behavior is observed. According to Section 48 of the test method:
48.1 Unless otherwise specified, the performance of protective membranes shall be determined as the time at which the following conditions occur:
48.1.1 The average temperature rise of any set of thermocouples for each class of element being protected is more than 250° F. (139° C.) above the initial temperature, or
48.1.2 The temperature rise of any one thermocouple of the set for each class of element being protected is more than 325° F. (181° C.) above the initial temperature.

For the conditions set forth in 48.1.1, Sample 1 protected the wall for an additional 4.3 minutes. For the conditions set forth in 48.1.2, Sample 1 protected the wall for an additional 4.0 minutes.

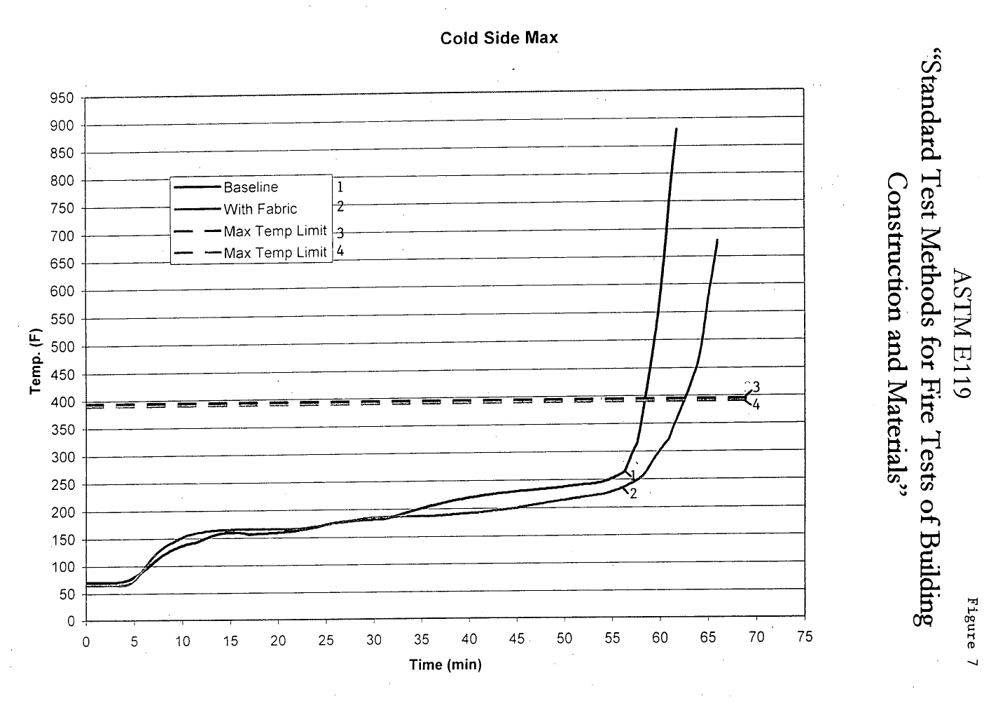

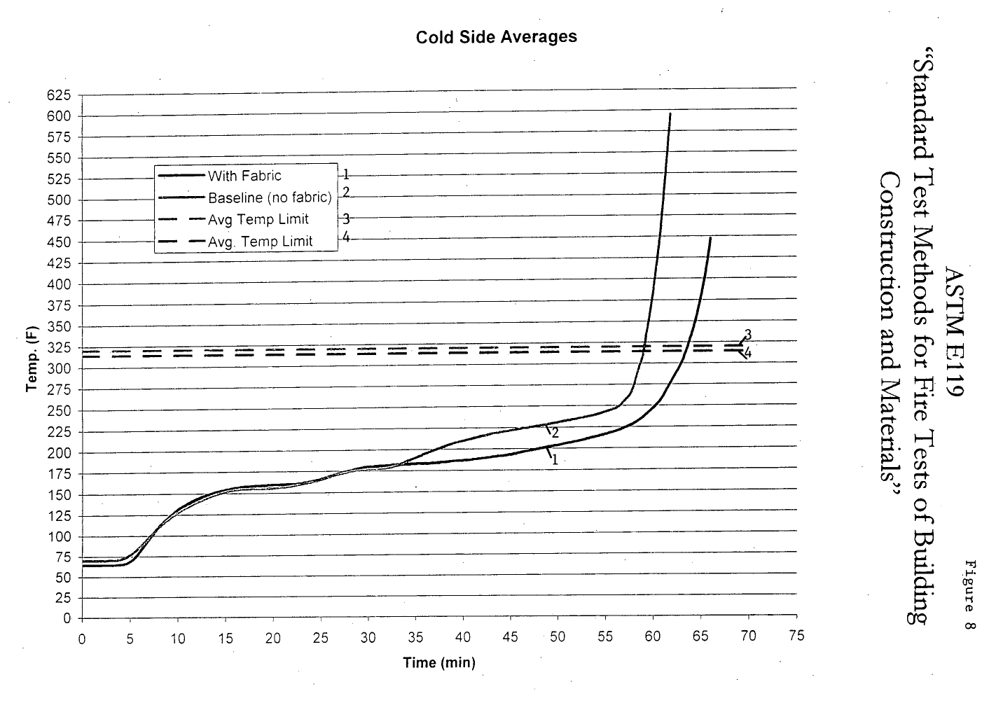

FIG. 7 is a graphical representation of time (minutes) versus Cold Side Max temperature (° F.) for (1) studded wall with wallboard only (Type X) and (2) for studded wall with wallboard (Type X) and the wallcovering of Sample 1 on both the interior wall and exterior wall. Type X refers to wallboard having noncombustible fibers added to the wallboard mixture during manufacture to give it flame resistance/heat resistance. FIG. 8 is a graphical representation of time (minutes) versus Average Cold Side temperature (° F.) for (1) studded wall with wallboard only (Type X) and (2) for studded wall with wallboard (Type X) and the wallcovering of Sample 1 on both the interior and exterior walls.

TABLE 5

| | Flame | | | Functional | | | |
|---|---|---|---|---|---|---|---|
| | Retardant - | Functional | Functional | Chemistry- | | | |
| | MYFLAME | Chemistry- | Chemistry- | FREEPEL | | | Additional |
| | 3921 (dry | PYROSAN | ULTRAFRESH | FC-45 (% | | | graphite in |
| Sample | ounce/sq yd) | SYN (% in | NM-V2 (% in | in finish | | | MYFLAME |
| No. | add on | finish mix) | finish mix) | mix) | Laminated | Stiffened | 3921?* |
| 1 | 3.4 | 0 | 0 | 0 | Yes | No | Yes |

*Note: for samples tested with “additional graphite”, the level used was twice the amount of the original.

### Example 4

A decorative flame barrier wall covering was prepared in accordance with the present invention. The following samples set forth in Table 6 were prepared from the wall covering and tested pursuant to ASTM Test Method C518, the “Standard Test Method for Steady-State Thermal Transmission Properties by Means of Heat Flow Meter Apparatus,” herein incorporated by reference. The results were based on the three samples prepared in accordance with Example 1 of the present invention and treated as set forth in Table 6.

TABLE 6

| | Flame Retardant - | Functional | Functional | Functional | | | |
|---|---|---|---|---|---|---|---|
| | MYFLAME | Chemistry- | Chemistry- | Chemistry- | | | Additional |
| | 3921 (dry | PYROSAN | ULTRAFRESH | FREEPEL | | | graphite in |
| Sample | ounce/sq yd) | SYN (% in | NM-V2 (% in | FC-45 (% in | | | MYFLAME |
| No. | add on | finish mix) | finish mix) | finish mix) | Laminated | Stiffened | 3921?* |
| 1 | 3.4 | 0 | 0 | 0 | Yes | No | Yes |
| 2 | 3.4 | 0 | 0 | 0 | Yes | No | Yes |
| 3 | 3.4 | 0 | 0 | 0 | Yes | No | Yes |

*Note: for samples tested with “additional graphite”, the level used was twice the amount of the original.

The results of the tests set forth in Table 7 were based on the average thermal transmission of three samples.

TABLE 7

| | Hot & | | | | |
|---|---|---|---|---|---|
| | Cold | Heat | Hot Plate | Cold Plate | Thermal |
| Sample | Separation | Flow | Temperature | Temperature | Transmission |
| No. | (mm) | (W/m2) | (° C.) | (° C.) | (W/m * K) |
| 1 | 17.40 | 129.87 | 38.8 | 23.0 | 0.1427 |
| 2 | 17.45 | 131.49 | 38.7 | 23.3 | 0.1496 |
| 3 | 17.02 | 130.57 | 38.9 | 23.3 | 0.1428 |
| Average | 17.29 | 130.64 | 38.8 | 23.2 | 0.1451 |

The average mean temperature of the three samples was 31.01° C. (87.82° F.). The average Thermal Conductivity of the three samples was 1.006 Btu-in/(° F.-ft²-h) (0.1451 W/(m*K)).

TABLE 8

| | Thickness | | |
|---|---|---|---|
| Thickness (in)* | (mm) | R (K * M²/W) | R (° F. * ft² * h/Btu) |
| 0.681 | 17.3 | 0.119 | 0.68 |

These results are based on the average thermal transmission of all three samples. The * represents the average thickness of three specimens. The decorative surface covering of the present invention, when mounted to ⅝″ X-grade wallboard, had an overall R-Factor of 0.68 (° F.*ft²*h/BTU). Overall, this was a 21% increase when compared to X-grade wallboard by itself.

### Example 5

A decorative flame barrier wall covering was prepared in accordance with Example 1 of the present invention. The following samples were obtained from the wall covering and were tested pursuant to ASTM Test Method 2471 for “Using Seeded-Agar for the Screening Assessment of Antimicrobial Activity in Carpets” (Modified), incorporated herein by reference. The modifications to the test method related to sample preparation (fabric discs were used instead of carpet) and the omission of the latter part of step 8.11 where additional “seeded agar” is poured to fill the dish (fabric immersed only, not flooded with additional agar). Both the face and back of the antimicrobial surface covering was tested. Reports from both surfaces of the material showed there to be “no growth of Aspergillus mold and Serratia bacteria” on either side of the tested product.

### Example 6

A decorative flame barrier wall covering was prepared in accordance with Example 1 of the present invention and a sample was prepared from the wall covering. The sample was treated as set forth in Table 9.

TABLE 9

| | | Functional | | | | | |
|---|---|---|---|---|---|---|---|
| | | Chemistry - | | | | | |
| | | PYROSAN | Functional | Functional | | | |
| | Flame Retardant - | SYN | Chemistry- | Chemistry- | | | Additional |
| | MYFLAME 3921 | (% in | ULTRAFRESH | FREEPEL | | | graphite in |
| Sample | (dry ounce/sq yd) | finish | NM-V2 (% in | FC-45 (% in | | | MYFLAME |
| No. | add on | mix) | finish mix) | finish mix) | Laminated | Stiffened | 3921?* |
| 1 | 3.5 | 20 | 1.6 | 2.50 | Yes | Yes | No |

*Note: for samples tested with “additional graphite”, the level used was twice the amount of the original.

The decorative side of the wall covering was tested under AATCC Test Method 118 for “Oil Repellency: Hydrocarbon Resistance Test,” incorporated herein by reference. The sample received an “8” rating which was the highest available score using the provided scoring system. The decorative surface was also tested for water/alcohol repellency under the DUPONT® test kit system for alcohol repellency. The sample received a “6” rating under the DUPONT® system which was also the highest available score using the provided scoring system.

The decorative side of the wall covering displayed a measurable amount of alcohol and oil repellency as tested via the DUPONT® test kit system and AATCC Test Method 118. In each method, samples of both alcohols and oils of increasing concentration were dropped via pipette onto the surface of the sample. If after 10 seconds for the alcohol sample and 30 seconds for the oil, the liquid had not completely “wet out” the surface, the material was said to have passed that particular concentration.

The result of the AATCC Test Method 118 for “Oil Repellency: Hydrocarbon Resistance Testing” (oil rating) was equal to 8, the maximum in this rating system. The result of the DuPont Oil/Water Repellency Test Kit (water and isopropanol (IPA)) was 6 which is its maximum wherein a rating of 1=2% IPA, a rating of 2=5% IPA, a rating of 3=10% IPA, a rating of 4=20% IPA, a rating of 5=30% IPA, and a rating of 6=40% IPA.

### Example 7

A decorative flame barrier wall covering was prepared in accordance with Example 1 of the present invention and tested in accordance with ASTM Test Method E90 for “Noise Reduction and Sound Transfer,” incorporated herein by reference. The wall covering had 3.5 (dry ounce/square yard) add on of flame barrier coating. There was no functional finish treatment on the wall covering. The wall covering was laminated and not stiffened. Additional graphite MYFLAME 3921 was added. The wall covering was mounted to both sides of a wooden studded wall with ⅝ inch type X wallboard also mounted to both sides. The addition of the sound transmission class (STC) was on the order of 1 point when compared to a wall constructed with wallboard and wooden studs only.

A wall covered with laminated fabric wall covering both sides was tested. The sample size was 50.7 square feet. The conditions were 42% relative humidity and 71° F. The following Table sets forth the empty room data after 80 decays for calibration purposes.

TABLE 10
Transmission Loss Report

| Test No. | Frequency | Reverb Times | Absorption |
|---|---|---|---|
| 19 | 80 | 5.28 | 154.2 |
| 20 | 100 | 9.31 | 87.5 |
| 21 | 125 | 6.68 | 122.0 |
| 22 | 160 | 7.14 | 114.0 |
| 23 | 200 | 6.18 | 131.8 |
| 24 | 250 | 8.33 | 97.7 |
| 25 | 315 | 8.92 | 91.3 |
| 26 | 400 | 8.27 | 98.4 |
| 27 | 500 | 8.77 | 92.9 |
| 28 | 630 | 8.36 | 97.4 |
| 29 | 800 | 7.32 | 111.3 |
| 30 | 1000 | 6.56 | 124.2 |
| 31 | 1250 | 5.16 | 157.9 |
| 32 | 1600 | 4.51 | 180.4 |
| 33 | 2000 | 4.14 | 196.6 |
| 34 | 2500 | 3.29 | 247.2 |
| 35 | 3150 | 2.49 | 326.6 |
| 36 | 4000 | 1.97 | 412.3 |
| 37 | 5000 | 1.58 | 516.5 |

TABLE 11
Sound Pressure Levels

| | | | | | | Outdoor/ |
|---|---|---|---|---|---|---|
| | | | | | | Indoor |
| | | | | Trans- | | Transmission |
| Test | | Source | Receiving | mission | Defi- | Class |
| No. | Frequency | Room | Room | Loss | ciencies | (OITC) |
| 19 | 80 | 103.7 | 77.3 | 22 | * | 59.4 |
| 20 | 100 | 102.0 | 78.4 | 21 | * | 61.9 |
| 21 | 125 | 106.0 | 83.1 | 19 | 1 | 70.9 |
| 22 | 160 | 103.5 | 79.9 | 20 | 3 | 70.3 |
| 23 | 200 | 101.1 | 76.5 | 20 | 6 | 70.3 |
| 24 | 250 | 98.6 | 71.6 | 24 | 5 | 66.0 |
| 25 | 315 | 98.4 | 67.1 | 29 | 3 | 62.9 |
| 26 | 400 | 94.5 | 59.7 | 32 | 3 | 57.7 |
| 27 | 500 | 91.3 | 55.2 | 33 | 3 | 55.1 |
| 28 | 630 | 90.1 | 48.4 | 39 | −2 | 49.2 |
| 29 | 800 | 92.3 | 48.9 | 40 | −2 | 51.5 |
| 30 | 1000 | 91.7 | 45.5 | 42 | −3 | 49.7 |
| 31 | 1250 | 91.7 | 42.7 | 44 | −4 | 48.3 |
| 32 | 1600 | 89.9 | 41.7 | 43 | −3 | 47.9 |
| 33 | 2000 | 88.9 | 44.7 | 38 | 2 | 52.1 |
| 34 | 2500 | 89.5 | 42.3 | 40 | 0 | 50.7 |
| 35 | 3150 | 90.0 | 37.1 | 45 | −5 | 46.2 |
| 36 | 4000 | 88.3 | 29.3 | 50 | −10 | 39.3 |
| 37 | 5000 | 83.3 | 21.3 | 52 | * | * |

Sound transmission class 36, sum of deficiencies below line 26, and OITC is 28.

A bare wall with three layers paper tape on each joint was tested. The sample size was 50.7 square feet. The conditions were 42% relative humidity and 71° F. The following Table 12 sets forth the empty room data after 80 decays.

TABLE 12

| Test No. | Frequency | Reverb Times | Absorption |
|---|---|---|---|
| 19 | 80 | 7.89 | 103.2 |
| 20 | 100 | 8.06 | 101.0 |
| 21 | 125 | 4.94 | 164.8 |
| 22 | 160 | 7.88 | 103.4 |
| 23 | 200 | 8.01 | 101.6 |
| 24 | 250 | 8.00 | 101.7 |
| 25 | 315 | 8.78 | 92.7 |
| 26 | 400 | 8.95 | 90.9 |
| 27 | 500 | 8.99 | 90.5 |
| 28 | 630 | 8.51 | 95.7 |
| 29 | 800 | 7.10 | 114.7 |
| 30 | 1000 | 6.25 | 130.3 |
| 31 | 1250 | 5.30 | 153.7 |
| 32 | 1600 | 4.66 | 174.9 |
| 33 | 2000 | 3.94 | 206.9 |
| 34 | 2500 | 3.24 | 251.3 |
| 35 | 3150 | 2.26 | 361.0 |
| 36 | 4000 | 1.93 | 422.9 |
| 37 | 5000 | 1.44 | 565.0 |

Sound transmission class 35, sum of deficiencies below line 30, and OITC is 27.

TABLE 13

| | | | | | | Outdoor/ |
|---|---|---|---|---|---|---|
| | | | | | | Indoor |
| | | | | Trans- | | Transmission |
| Test | | Source | Receiving | mission | Defi- | Class |
| No. | Frequency | Room | Room | Loss | ciencies | (OITC) |
| 19 | 80 | 103.7 | 78.6 | 22 | * | 59.3 |
| 20 | 100 | 103.2 | 80.3 | 20 | * | 64.1 |
| 21 | 125 | 103.9 | 81.4 | 17 | 2 | 70.8 |
| 22 | 160 | 103.2 | 82.1 | 18 | 4 | 72.0 |
| 23 | 200 | 100.4 | 77.3 | 20 | 5 | 69.6 |
| 24 | 250 | 99.1 | 71.5 | 25 | 3 | 65.5 |
| 25 | 315 | 98.9 | 69.6 | 27 | 4 | 65.4 |
| 26 | 400 | 94.3 | 60.8 | 31 | 3 | 58.5 |
| 27 | 500 | 91.0 | 56.1 | 32 | 3 | 55.8 |
| 28 | 630 | 89.5 | 49.3 | 37 | −1 | 50.6 |
| 29 | 800 | 91.1 | 49.0 | 39 | −2 | 51.3 |
| 30 | 1000 | 90.4 | 45.9 | 40 | −2 | 50.4 |
| 31 | 1250 | 89.9 | 42.5 | 43 | −4 | 47.5 |
| 32 | 1600 | 87.6 | 41.8 | 40 | −1 | 48.6 |
| 33 | 2000 | 86.0 | 44.7 | 35 | 4 | 52.2 |
| 34 | 2500 | 86.0 | 41.6 | 37 | 2 | 50.2 |
| 35 | 3150 | 87.7 | 37.4 | 42 | −3 | 46.9 |
| 36 | 4000 | 87.1 | 31.4 | 47 | −8 | 41.1 |
| 37 | 5000 | 79.3 | 21.3 | 47 | * | * |

### Example 8

A decorative flame barrier wall covering was prepared in accordance with Example 1 of the present invention. The sample was treated as shown in Table 14.

TABLE 14

| | Flame Retardant - | Functional | Functional | Functional | | | |
|---|---|---|---|---|---|---|---|
| | MYFLAME | Chemistry- | Chemistry- | Chemistry- | | | Additional |
| | 3921 (dry | PYROSAN | ULTRAFRESH | FREEPEL | | | graphite in |
| Sample | ounce/sq yd) | SYN (% in | NM-V2 (% in | FC-45 (% in | | | MYFLAME |
| No. | add on | finish mix) | finish mix) | finish mix) | Laminated | Stiffened | 3921?* |
| 1 | 3.5 | 20 | 1.6 | 2.5 | Yes | Yes | No |
| 2 | 2.8 | 0 | 0 | 0 | Yes | Yes | No |
| 3 | 3.1 | 0 | 1.6 | 2.5 | Yes | Yes | No |
| 4 | 8.3 | 0 | 0 | 0 | Yes | No | No |

*Note: for samples tested with “additional graphite”, the level used was twice the amount of the original.

Each sample was tested for “breathability” in accordance with ASTM Test Method E96 for “Standard Test Methods for Water Vapor Transmission of Materials,” herein incorporated by reference. The “Water Method” version of the standard was used. According to the method, the wall covering material was sealed over the opening of a glass jar (with a known weight of water in the jar). After a period of 24 hours under controlled temperature, humidity, and air flow conditions, the weights of the water remaining in the jar and the actual sample weight were used to determine the degree to which the test sample allows water to permeate.

The Moisture Vapor Transfer (MVT) results yielded the following data following the ASTM E96 upright method: Temperature/Humidity: 70° F./50% over a 24 hour period.

TABLE 15

| Sample 1 | | Sample 2 | | Sample 3 | | Sample 4 | |
|---|---|---|---|---|---|---|---|
| 1165 | g/m²/ | 1918 | g/m²/24 hr | 1311 | g/m²/24 hr | 2290 | g/m²/24 hr |
| | 24 hr | | | | | | |
| 1337 | | 1894 | | 1445 | | 1521 | |
| 1211 | | 1911 | | 1500 | | 650 | |
| 1256 | | 1856 | | 1134 | | 1844 | |
| 1242 | | 1894 | | 1348 | | 1576 | |

Sample 4 had a significant variation as evidenced from the above numbers. The variation may be due to compound, method or finish. According to the interpretation of the test results, any number above 1000 g/m²/24 hr for an upright method is equivalent to performance numbers for breathable outerwear in the industry.

The Moisture Vapor Transfer To Permeance Conversion was calculated as follows:

MVT=Moisture vapor transfer

S=1.378 in Hg (from standard reference tables)

R1=Relative Humidity between wallcovering sample and water

R2=Relative Humidity of test room

Perms=grains (of water)/(sq ft*h*in. Hg)

Permeance=MVT/ΔP

$$P = \frac{1242 grains / ( \text{sq} m * 24 \text{hr} )}{[ S ( R 1 - R 2 ) ]}$$

$$P = \frac{1242 grains / [ ( \text{sq} m * 24 \text{hr} * ( 9.29 \text{sq} ft \text{/} \text{sq} \text{m} ) ]}{[ S ( R 1 - R 2 ) ]}$$

$$P = \frac{5.57 grains / ( \text{sq} ft * \text{hr} )}{1.38 in \text{Hg} ( 1.00 - 0.50 )}$$

$$P = \frac{5.57 grains / ( \text{sq} ft * \text{hr} )}{0.69 in \text{Hg}}$$

$$P = \frac{[ 5.57 grains * ( 1 \text{/} 0.69 in \text{Hg} ) ] / ( \text{sq} ft * \text{hr} )}{0.69 in \text{Hg} * ( 1 \text{/} 0.69 in \text{Hg} )}$$

P=8.07 grains/[(sq ft*hr*in Hg)]

P=8.07 Perms

TABLE 16

| Sample 1 | Sample 2 | Sample 3 | Sample 4 |
|---|---|---|---|
| 8.07 Perms | 12.3 Perms | 8.76 Perms | 10.24 Perms |

### Example 9

The following high lightfastness pigments commercially available from Dystar L.P. (IMPERON® pigments and ACRAMIN® pigments) and Tru-Chem Company, Inc. (TRU-CHEM® pigments) were printed onto a wall covering made in accordance with Example 1 of the present invention and tested pursuant to AATCC (American Association of Textile Colorists and Chemists) Test Method 16, incorporated herein by reference:

| | Pigment Color Index Number |
|---|---|
| High Lightfast Pigment | (CI) |
| IMPERON ® Gold Yellow HF-R | Not Available |
| IMPERON ® Red Brown HF-G | Not Available |
| IMPERON ® Red HF-S | Not Available |
| TRU-CHEM ® Blue 3GWP | Blue 15.3 |
| TRU-CHEM ® Blue WPS | Blue 15.1 |
| TRU-CHEM ® Violet BFC | Violet 23 |
| ACRAMIN ® Green BN-W | Green 7 |

At the maximum strength dyed, the above samples rated a 4 (out of a 1-5 scale with 1 being the lowest rating and 5 being the highest) after 1,000 hours of accelerated lightfastness testing.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of making a decorative flame barrier surface covering, the method comprising:
(a) obtaining a first material as a base layer,
(b) applying a stiffening solution to the base layer,
(c) applying a flame barrier coating to the stiffened base layer,
(d) obtaining a second material having a decorative design thereon as a decorative layer,
(e) optionally applying a functional finish on the decorative layer, and
(f) combining the base layer with the decorative layer to form the decorative flame barrier surface covering.

2. The method according to claim 1, wherein the surface is a wall, floor, or ceiling.

3. The method according to claim 1, wherein the first material is knit, woven, non-woven, or a combination thereof.

4. The method according to claim 1, wherein the second material is knit, woven, non-woven, or a combination thereof.

5. The method according to claim 1, wherein the first material is synthetic, natural, or a combination thereof.

6. The method according to claim 5, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

7. The method according to claim 5, wherein the natural material is selected from the group consisting of wood pulp, cotton, jute, flax, ramie, hemp, kenaf, abaca, nettles, bamboo, esparto, coir, and sisal.

8. The method according to claim 1, wherein the second material is synthetic, natural, or a combination thereof.

9. The method according to claim 8, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

10. The method according to claim 8, wherein the natural material is selected from the group consisting of wood pulp, cotton, jute, flax, ramie, hemp, kenaf, abaca, nettles, bamboo, esparto, coir, and sisal.

11. The method according to claim 1, wherein the stiffening solution is a polymeric solution.

12. The method according to claim 11, wherein the polymeric solution is an acrylic emulsion.

13. The method according to claim 1, wherein the flame barrier coating is an intumescent graphite coating.

14. The method according to claim 1, wherein the functional finish is selected from the group consisting of a flame retardant; anti-fungal agent; antimicrobial agent; stain repellent, wrinkle-resistant finish, or a combination thereof.

15. A method of making a decorative flame barrier surface covering, the method comprising:
(a) obtaining a first material as a base layer,
(b) applying a stiffening solution to the base layer,
(c) applying a flame barrier coating to the stiffened base layer,
(d) obtaining a second material,
(e) printing a decorative design on the second material layer to form a decorative layer,
(f) optionally applying a functional finish on the decorative layer, and
(g) inserting an adhesive layer between the base layer and the decorative layer to form the decorative flame barrier surface covering.

16. The method according to claim 15, wherein the surface is a wall, floor, or ceiling.

17. The method according to claim 15, wherein the first material is knit, woven, non-woven, or a combination thereof.

18. The method according to claim 15, wherein the second material is knit, woven, non-woven, or a combination thereof.

19. The method according to claim 15, wherein the first material is synthetic, natural, or a combination thereof.

20. The method according to claim 19, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

21. The method according to claim 19, wherein the natural material is selected from the group consisting of wood pulp, cotton, jute, flax, ramie, hemp, kenaf, abaca, nettles, bamboo, esparto, coir, and sisal.

22. The method according to claim 15, wherein the second material is synthetic, natural, or a combination thereof.

23. The method according to claim 22, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

24. The method according to claim 22, wherein the natural material is selected from the group consisting of wood pulp, cotton, jute, flax, ramie, hemp, kenaf, abaca, nettles, bamboo, esparto, coir, and sisal.

25. The method according to claim 15, wherein the stiffening solution is a polymeric solution.

26. The method according to claim 25, wherein the polymeric solution is an acrylic emulsion.

27. The method according to claim 15, wherein the flame barrier coating is an intumescent graphite coating.

28. The method according to claim 15, wherein the functional finish is selected from the group consisting of a flame retardant; anti-fungal agent; antimicrobial agent; stain repellent, wrinkle-resistant finish, or a combination thereof.

29. A method of making a decorative flame barrier wall covering, the method comprising:
(a) obtaining a first non-woven as a base layer,
(b) applying a stiffening solution to the base layer,
(c) foaming a flame barrier coating,
(d) applying the foamed flame barrier coating to the stiffened base layer,
(e) obtaining a second non-woven having a decorative design thereon as a decorative layer,
(f) optionally applying a functional finish on the decorative layer, and
(g) combining the base layer with the decorative layer to form the decorative flame barrier wall covering.

30. The method according to claim 29, wherein the first non-woven is synthetic, natural, or a combination thereof.

31. The method according to claim 30, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

32. The method according to claim 30, wherein the natural material is selected from the group consisting of wood pulp, cotton, jute, flax, ramie, hemp, kenaf, abaca, nettles, bamboo, esparto, coir, and sisal.

33. The method according to claim 29, wherein the second non-woven is synthetic, natural, or a combination thereof.

34. The method according to claim 33, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

35. The method according to claim 33, wherein the natural material is selected from the group consisting of wood pulp, cotton, jute, flax, ramie, hemp, kenaf, abaca, nettles, bamboo, esparto, coir, and sisal.

36. The method according to claim 29, wherein the stiffening solution is a polymeric solution.

37. The method according to claim 36, wherein the polymeric solution is an acrylic emulsion.

38. The method according to claim 29, wherein the flame barrier coating is an intumescent graphite coating.

39. The method according to claim 29, wherein the functional finish is selected from the group consisting of a flame retardant; anti-fungal agent; antimicrobial agent; stain repellent, wrinkle-resistant finish, or a combination thereof.

40. The method according to claim 29, wherein the decorative flame barrier wall covering has a thickness in a range of from about 0.03 inches to about 0.06 inches.

41. The method according to claim 29, wherein foaming is subject to a blow ratio of air to flame barrier coating of from about 0.8:1 to about 2:1.

42. A decorative flame barrier surface covering comprising:
(a) a first, stiffened material treated with a flame barrier coating, and
(b) a second material having a decorative design printed thereon,
wherein the decorative flame barrier surface covering achieves a Class A certification under American Society for Testing and Materials standard E84-04 without an inherently flame-resistant material as the first or second material.

43. The decorative flame barrier surface covering according to claim 42, wherein the surface is a wall, floor, or ceiling.

44. The decorative flame barrier surface covering according to claim 42, wherein the first material is knit, woven, non-woven, or a combination thereof.

45. The decorative flame barrier surface covering according to claim 42, wherein the second material is knit, woven, non-woven, or a combination thereof.

46. The decorative flame barrier surface covering according to claim 42, wherein the first material is synthetic, natural, or a combination thereof.

47. The decorative flame barrier surface covering according to claim 46, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

48. The decorative flame barrier surface covering according to claim 46, wherein the natural material is selected from the group consisting of wood pulp, cotton, jute, flax, ramie, hemp, kenaf, abaca, nettles, bamboo, esparto, coir, and sisal.

49. The decorative flame barrier surface covering according to claim 42, wherein the second material is synthetic, natural, or a combination thereof.

50. The decorative flame barrier surface covering according to claim 49, wherein the synthetic material is selected from the group consisting of polyamide, acetate, nylon, modacrylic, olefin, acrylic, polyester, polylactic acid (PLA), aramid, modal, sulfar, zylon, rayon, and lyocell.

51. The decorative flame barrier surface covering according to claim 49, wherein the natural material is selected from the group consisting of wood pulp, cotton, jute, flax, ramie, hemp, kenaf, abaca, nettles, bamboo, esparto, coir, and sisal.

52. The decorative flame barrier surface covering according to claim 42, wherein the flame barrier coating is an intumescent graphite coating.

53. A decorative flame barrier wall covering comprising:
(a) a first, stiffened material treated with a flame barrier coating,
(b) an adhesive layer, and
(c) a second material having a decorative design printed thereon, wherein the decorative flame barrier surface covering achieves a Class A certification under American Society for Testing and Materials standard E84-04 without an inherently flame-resistant material as the first or second material.

54. The decorative flame barrier wall covering according to claim 53, wherein the decorative flame barrier wall covering has a thickness in a range of from about 0.03 inches to about 0.06 inches.

55. The decorative flame barrier wall covering according to claim 53, further comprising a functional finish.

56. The decorative flame barrier surface covering according to claim 53, wherein the flame barrier coating is an intumescent graphite coating.

57. The decorative flame barrier surface covering according to claim 56, wherein the functional finish is selected from the group consisting of a flame retardant; anti-fungal agent; antimicrobial agent; stain repellent, wrinkle-resistant finish, or a combination thereof.
